(19) United States
(12) Patent Application Publication
(10) Pub. No.: US 2007/0268228 A1
(43) Pub. Date: Nov. 22, 2007

(54) Data driver and driving method of a flat panel display

(75) Inventor: Wei-Jhih Lian, Chungho City (TW)

Correspondence Address: BIRCH STEWART KOLASCH & BIRCH, PO BOX 747, FALLS CHURCH, VA, 22040-0747, US

(73) Assignee: CHUNGHWA PICTURE TUBES, LTD.

(21) Appl. No.: 11/509,687

(22) Filed: Aug. 25, 2006

(30) Foreign Application Priority Data
May 18, 2006 (TW) 95117725

(51) Int. Cl. G09G 3/36

(52) U.S. Cl. 345/100

(57) ABSTRACT

A data driver of a flat panel display comprises an input register, at least one ramp signal unit, a counter and a switch device. The input register receives a control signal and an N-bit digital image data, and outputs respectively a most significant bit and the remaining (N-1) bits of the N-bit digital image data. The ramp signal unit generates a ramp signal according to the most significant bit. The counter counts the clock number and generates a switch device control signal after a clock counted time represented by the remaining (N-1) bits of the N-bits digital image data. The switch device transmits a voltage of the ramp signal to a data line of a flat panel display according to the switch device control signal.

### RELATED APPLICATIONS

The present application is based on, and claims priority from, Taiwan Application Serial Number 95117725, filed May 18, 2006, the disclosure of which is hereby incorporated by reference herein in its entirety.

### BACKGROUND

1. Field of Invention

The present invention relates to a data driver of a flat panel display. More particularly, the present invention relates to a data driver and driving method generating different ramp signals according to a specific bit of the digital image data.

2. Description of Related Art

Modern flat panel displays (FPD) have high image quality, compact sizes, light weights, low driving voltages and low power consumption. Because of these advantages, FPD have become very popular for incorporation into electrical devices and they have become the mainstream display apparatus. For example, the FPD can be introduced into portable televisions (TV), mobile phones, video recorders, computer monitors, and many other kinds of consumer electronic devices.

Several source drivers (i.e. data drivers) drive the FPD and can transform the digital data (image data) into analog voltages for a FPD display unit. The gamma curve relationship between the light passing through the display units and the analog voltages applied on the display unit is nonlinear. Therefore, data drivers have gamma-voltage generating circuits to correct the analog voltages applied on the display unit. The gamma-voltage generating circuits can make the analog voltages applied on the display unit correspond to the gamma curve variation when the digital data is transformed into analog voltages.

FIG. 1 is a circuit diagram transforming a digital image data into an analog voltage in a traditional data driver. This kind of circuit is composed of resistor strings RS1, RS2, RS3 . . . RS16, wherein the reference voltages VGMA1, VGMA2 . . . VGMAl8 are used to stabilize the voltages. Each resistor string has more than one resistor to supply more than one voltage. The required voltages V1, V2 . . . V512 can be obtained from the connecting points between the resistors included in the resistor strings. The DAC (digital to analog converter) circuit is shown on the right hand side of FIG. 1. The DAC circuit selects the 2^{N} voltages for the resistor strings in the upper portion on the left hand side according to an N-bit digital image data. For example, for an 8-bit digital image, the DAC circuit selects 2⁸=256 voltages for the resistor strings of the upper portion on the left hand side of FIG. 1. Each bit of the digital image data is used to control a switch group, wherein the switch group is illustrated as all the switches controlled by the LSB (less significant bit) D1. The voltages V1, V2 . . . V256 or V257, V258 . . . V512 are generated as an output voltage 180 by turning on or turning off of the switch groups, In FIG. 1, the LSB (D₁) 110 of the digital image data is used to control the switch group on the left-most side; the MSB (D_{N}) 150 of the digital image data is used to control the switch group on the right-most side, and the other switch groups are respectively and correspondingly controlled by the other bits D₂˜D_{N-1} between the LSB and MSB. Using the method described above, the voltages V1, V2 . . . V256 or V257, V258 . . . V512 are generated as an output voltage 180. For example, when the D₁ (LSB), D₂ . . . D_{N} (MSB) of digital image data makes the switch S₁, S₂ . . . S_{N} conductive, the output voltage 180 is V1. This kind of DAC circuit design needs a large number of resistor strings and switch groups. Therefore, this kind of design requires a big chip area and more energy is consumed during the operation.

Another DAC circuit design is based on a ramp signal. FIG. 2 is a waveform diagram depicting a ramp signal 210 generated by a traditional ramp signal generator. Tₜ represents the longest time the digital image data is displayed, and Vₜ is the largest analog voltage that can drive each FPD liquid crystal cell. Therefore, the ramp signal 210 can supply an analog voltage to the liquid crystal cell over the period of time the digital image data is displayed. The period of time is measured by a clock signal and the maximum period of time is Tt represented by the digital image data For example, when the digital image data is displayed over a time period T₀, the ramp signal 210 supplies an output voltage of V0.

This DAC circuit design is based on a ramp signal generator. The required voltage is obtained by increasing the signal voltage from the lowest voltage to the highest voltage. Therefore, when digital image data requires a high analog voltage, the ramp signal needs more time to get the high analog voltage. Accordingly, the flat panel display needs a longer frame time. Moreover, when dealing with a lot of data in high-resolution images, the DAC circuit design based on a ramp signal has to use a ramp signal generator with increased high voltage speed. However, this kind of ramp signal generator with and increased high voltage speed has higher cost and the output voltage is less precise.

### SUMMARY

It is therefore an aspect of the present invention to provide a data driver and a driving method for a flat panel display to generate a ramp signal according to the image digital data MSB. Wherein the largest affordable voltage supplied by the ramp signal is only half of the largest analog voltage that can drive each liquid crystal cell of the flat panel display. The range of the voltage variance is smaller during the same time; therefore the present invention can supply more precise output voltages.

According to one preferred embodiment of the present invention, the data driver of a flat panel display has an input register, a ramp signal unit, a counter and a switch device. The input register is arranged to receive a control signal and an N-bit digital image data, wherein the control signal controls the input register to output respectively a most significant bit and the remaining (N-1) bits of the N-bit digital image data. The ramp signal unit is arranged to generate a ramp signal according to the received most significant bit. The ramp signal unit has a ramp signal generator to generate a first pre-selected ramp signal, a reverse circuit to reverse the first pre-selected ramp signal to be a second pre-selected ramp signal, and a ramp signal selector to select a ramp signal from the first pre-selected ramp signal and the second pre-selected ramp signal according to the most significant bit. The counter is arranged to count the clock number and to generate a switch device control signal after the clock counted time represented by the remaining (N-1) bits of the N-bits digital image data. The switch device is arranged to transmit a ramp signal voltage to a flat panel display data line according to the switch device control signal.

According to another preferred embodiment of the present invention, the driving method of a flat panel display includes receiving a control signal and an N-bit digital image data, outputting respectively a most significant bit and the remaining (N-1) bits of the N-bit digital image data according to the control signal, generating a ramp signal according to the most significant bit. Wherein the step of generating the ramp signal includes using a ramp signal generator to generate a first pre-selected ramp signal, using a reverse circuit to reverse the first pre-selected ramp signal to be a second pre-selected ramp signal; and using a ramp signal selector to select a ramp signal from the first pre-selected ramp signal and the second pre-selected ramp signal according to the most significant bit. Finally, the method outputs a ramp signal voltage to a flat panel display data line after a clock counted time represented by the remaining (N-1) bits of the N-bit digital image data.

It is to be understood that both the foregoing general description and the following detailed description are examples and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a circuit diagram transforming a digital image data into an analog voltage in a traditional data driver.

FIG. 2 is a waveform diagram depicting a ramp signal generated by a traditional ramp signal generator.

FIG. 3 is a functional diagram depicting one preferred embodiment of the present invention.

FIG. 4 is a functional diagram depicting a ramp signal unit of another preferred embodiment of the present invention.

FIG. 5A is a waveform diagram depicting a ramp signal generated by a preferred embodiment of the present invention.

FIG. 5B is a waveform diagram depicting another ramp signal generated by a preferred embodiment of the present invention.

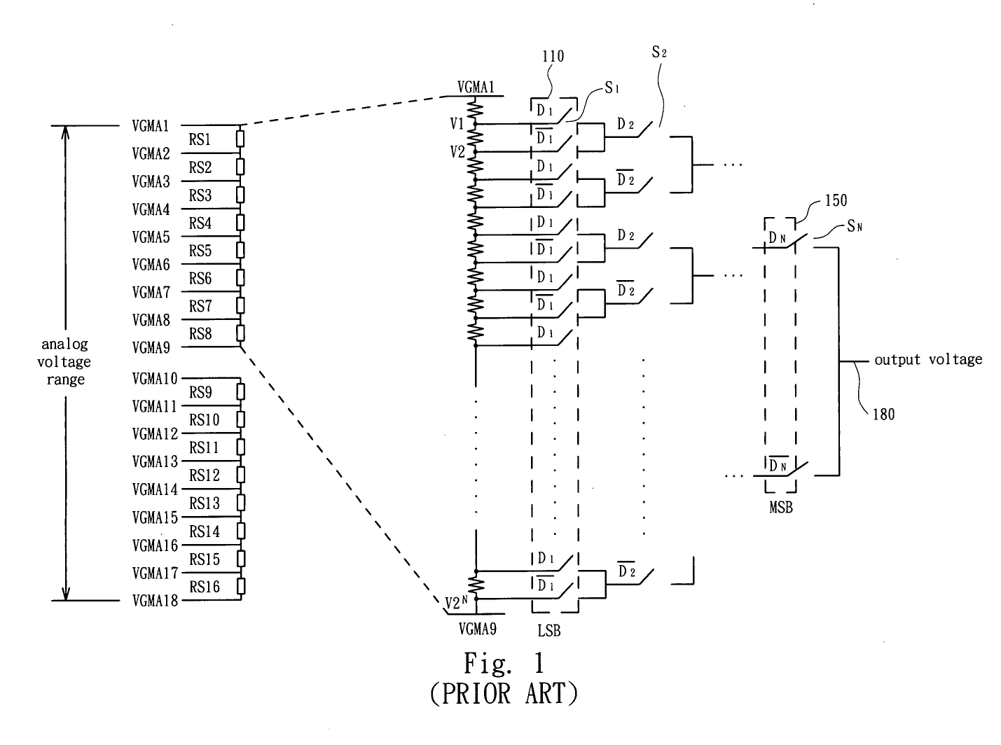

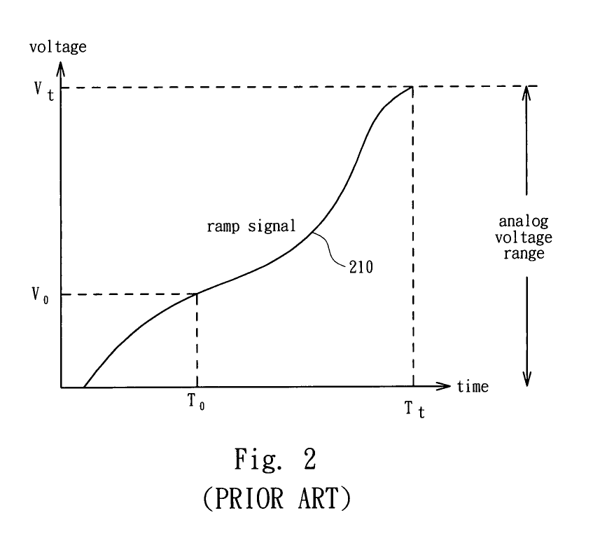

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

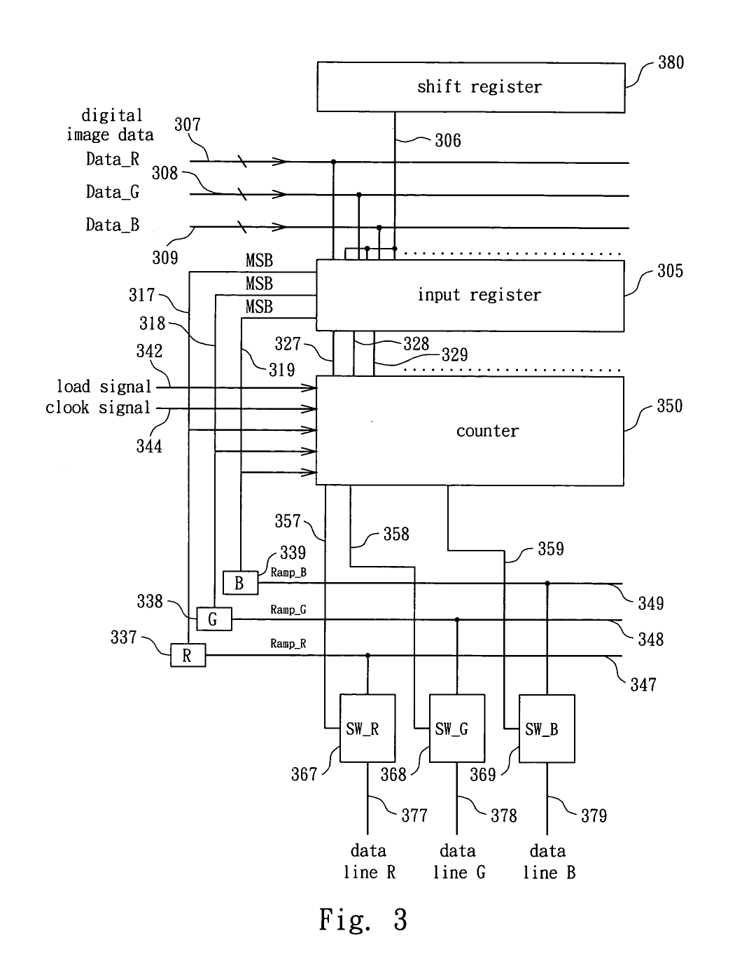

FIG. 3 is a functional diagram depicting one preferred embodiment of the present invention. The data driver has an input register 305, several ramp signal units 337, 338 and 339 corresponding to the different colored digital image data of different colors, a counter 350 and several switch devices 367, 368 and 369 corresponding to the digital image data of different colors. The input register 305 receives a control signal 306 and N-bit digital image data 307, 308 and 309, wherein the control signal 306 controls the input register 305 to output respectively a most significant bit 317, 318 and 319, and the remaining (N-1) bits 327, 328 and 329 of the N-bits digital image data. The ramp signal unit 337, 338 and 339 are arranged to generate several ramp signals 347, 348 and 349 according to the received most significant bits of different colors.

The counter 350 is arranged to count the clock number and to generate several switch device control signals 357, 358 and 359 of different colors after a clock counted time represented by the remaining (N-1) bits 327, 328 and 329 of the N-bit digital image data. The switch devices 367, 368 and 369 of different colors are arranged to transmit voltages of several ramp signals 347, 348 and 349 to the data lines 377, 378 and 379 of a flat panel display according to the switch device control signals 347, 348 and 349. Wherein the load signal 342 controls the counter 350 to count the clock number, and the clock signal 344 is the basic time unit signal for counting the clock number.

The preferred embodiment of the present invention described above respectively deals with the N-bit digital image data and generates the ramp signal of one color. Take the digital image data (Data_R) 307 for example; the input register 305 outputs respectively a most significant bit (MSB) 317 and the remaining (N-1) bits 327 according to the control signal 306. The counter 350 counts the clock number according to the remaining (N-1) bits 327 of the Data_R and generates a switch device control signal 357 to conduct the switch device 367 to transmit a voltage of the ramp signal 347 to a data line 377 of a flat panel display.

Otherwise, the preferred embodiment of the present invention further comprises a shift register 380 to generate the control signal 306. Furthermore, the N-bit digital image data of the preferred embodiment represents a plurality of gamma voltages of red, green or blue. When the digital image data of more colors are used, we can use the same architecture to get the digital image of other colors.

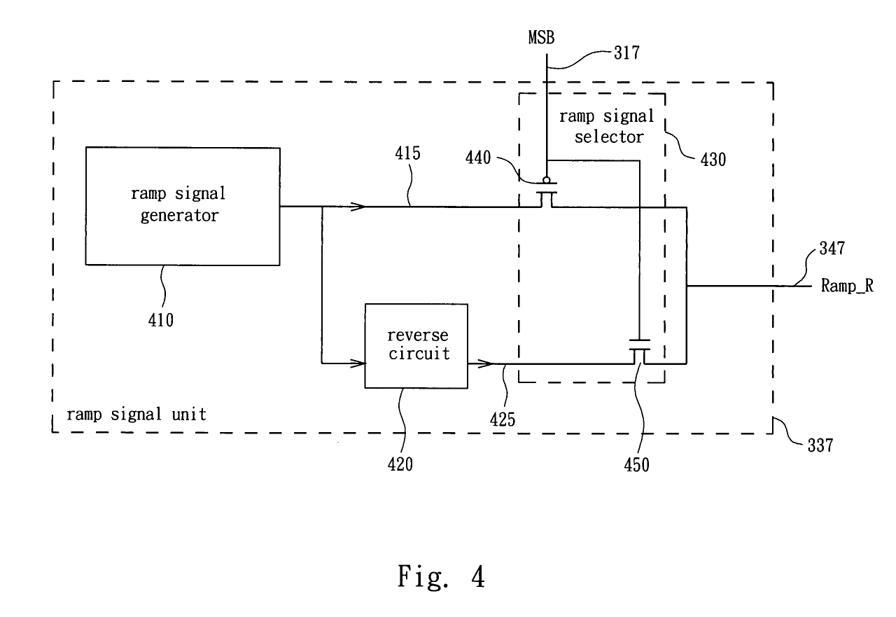

FIG. 4 is a functional diagram depicting a ramp signal unit of another preferred embodiment of the present invention. The functional diagrams of the ramp signal units 337, 338 and 339 are the same. Take the red color ramp signal unit 337 for example; the ramp signal unit 337 has a ramp signal generator 410, a reverse circuit 420, and a ramp signal selector 430. The ramp signal generator 410 generates a first pre-selected ramp signal 415. The reverse circuit 420 reverses the first pre-selected ramp signal 415 to be a second pre-selected ramp signal 425. The ramp signal selector 430 selects a ramp signal 347 (Ramp_R) from the first pre-selected ramp signal 415 and the second pre-selected ramp signal 425 according to the most significant bit 317.

The ramp signal selector 430 has a first transistor 440 and a second transistor 450. A source of the first transistor 440 couples to the ramp signal generator 410, a gate of the first transistor 440 couples to an input end of the most significant bit to receive the most significant bit 317, a drain of the first transistor 440 couples to an output end of the ramp signal to output the ramp signal 347. A source of the second transistor 450 couples to the reverse circuit 420, a gate of the second transistor 450 couples to the input end of the most significant bit to receive the most significant bit 317, a drain of the second transistor 450 couples to the output end of the ramp signal to output the ramp signal 347.

Otherwise, when the first transistor 440 is a P-type transistor; the second transistor 450 is an N-type transistor; when the first transistor 440 is an N-type transistor; the second transistor 450 is a P-type transistor. Therefore, one ramp signal 347 can be selected from the first pre-selected ramp signal 415 and the second pre-selected ramp signal 425 by the ramp signal selector 430.

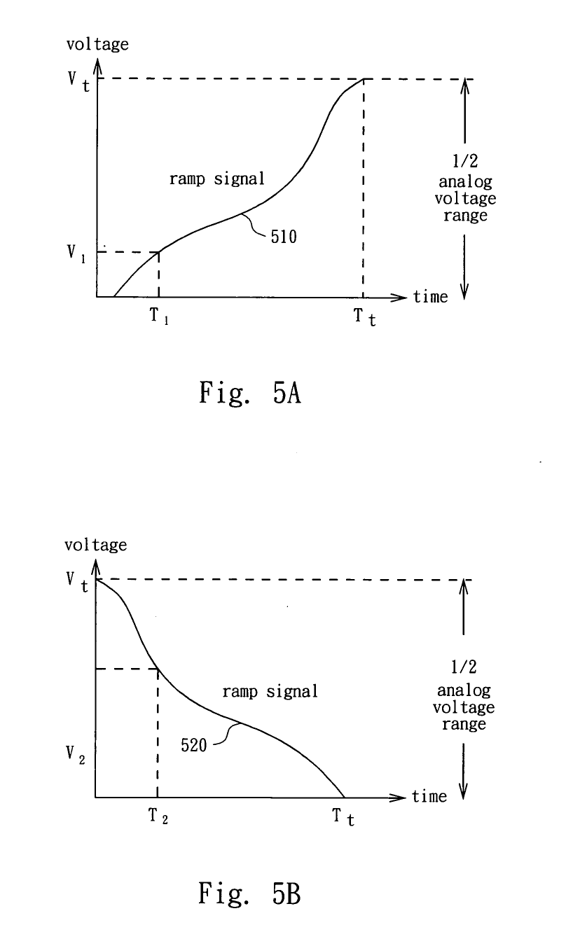

FIG. 5A is a waveform diagram depicting a ramp signal generated by a preferred embodiment of the present invention. The ramp signal 510 increases from the lowest voltage to the highest voltage Vₜ during the longest clock counted time represented by the remaining (N-1) bits of the N-bit digital image data. When the counter 350 of FIG. 3 counts the clock number of T₁, the ramp signal unit outputs the voltage V₁ of the ramp signal 510 to the data line of the flat panel display. Moreover, the interval Vₜ between the highest voltage and the lowest voltage covers half the analog voltage range driving a liquid crystal unit. The range of the voltage variance is smaller during the same time; therefore the preferred embodiment of the present invention can supply more precise analog voltages.

FIG. 5B is a waveform diagram depicting a ramp signal generated by a preferred embodiment of the present invention. The ramp signal 520 decreases from the highest voltage Vₜ to the lowest voltage during the longest clock counted time represented by the remaining (N-1) bits of the N-bit digital image data. When the counter 350 of FIG. 3 counts the clock number of T₂, the ramp signal unit outputs the voltage V₂ of the ramp signal 520 to the data line of the flat panel display. Moreover, the interval Vₜ between the highest voltage and the lowest voltage covers half the analog voltage range driving a liquid crystal unit. The range of the voltage variance is smaller during the same time; therefore the preferred embodiment of the present invention can supply more precise analog voltages.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A data driver of a flat panel display, comprising:
an input register arranged to receive a control signal and an N-bit digital image data, wherein the control signal controls the input register to output respectively a most significant bit and the remaining (N-1) bits of the N-bit digital image data;
at least one ramp signal unit coupled to the input register and arranged to generate a ramp signal according to the received most significant bit, wherein the ramp signal unit comprises:
a ramp signal generator arranged to generate a first pre-selected ramp signal;
a reverse circuit coupled to the ramp signal generator and arranged to reverse the first pre-selected ramp signal to be a second pre-selected ramp signal; and
a ramp signal selector arranged to select the ramp signal from the first pre-selected ramp signal and the second pre-selected ramp signal according to the most significant bit;
a counter coupled to the input register and arranged to count the clock number and to generate a switch device control signal after a clock counted time represented by the remaining (N-1) bits of the N-bit digital image data; and
a switch device coupled to the ramp signal unit and the counter and arranged to transmit a voltage of the ramp signal to a data line of a flat panel display according to the switch device control signal.

2. The data driver as claimed in claim 1, wherein the first pre-selected ramp signal or the second pre-selected ramp signal begins from a highest voltage or a lowest voltage that covers half an analog voltage range driving a liquid crystal unit of the flat panel display.

3. The data driver as claimed in claim 1, further comprising a shift register to generate the control signal.

4. The data driver as claimed in claim 1, wherein the N-bits digital image data represents a plurality of gamma voltages of red, green or blue.

5. The data driver as claimed in claim 1, wherein the ramp signal selector comprises:
a first transistor, wherein a source of the first transistor couples to the ramp signal generator, a gate of the first transistor couples to an input end of the most significant bit to receive the most significant bit, a drain of the first transistor couples to an output end of the ramp signal to output the ramp signal; and
a second transistor, wherein a source of the second transistor couples to the reverse circuit, a gate of the second transistor couples to the input end of the most significant bit to receive the most significant bit, a drain of the second transistor couples to the output end of the ramp signal to output the ramp signal.

6. The data driver as claimed in claim 5, wherein the first transistor is a P-type transistor; the second transistor is an N-type transistor.

7. The data driver as claimed in claim 5, wherein the first transistor is an N-type transistor; the second transistor is a P-type transistor.

8. A driving method of a flat panel display, comprising:
receiving a control signal and a N-bits digital image data;
outputting respectively a most significant bit and the remaining (N-1) bits of the N-bits digital image data according to the control signal;
generating a ramp signal according to the most significant bit, wherein the step of generating the ramp signal comprises:
using a ramp signal generator to generate a first pre-selected ramp signal;
using a reverse circuit to reverse the first pre-selected ramp signal to be a second pre-selected ramp signal;
using a ramp signal selector to select the ramp signal from the first pre-selected ramp signal and the second pre-selected ramp signal according to the most significant bit; and
outputting a voltage of the ramp signal to a data line of a flat panel display after a clock counted time represented by the remaining (N-1) bits of the N-bits digital image data.

9. The driving method as claimed in claim 8, wherein when generating the ramp signal according to the most significant bit, the ramp signal begins from a highest voltage or a lowest voltage that covers half an analog voltage range driving a liquid crystal unit of the flat panel display.

10. The driving method as claimed in claim 8, wherein the N-bit digital image data represents a plurality of gamma voltages of red, green or blue.

11. The driving method as claimed in claim 8, wherein the step of using the ramp signal selector comprises:
using a first transistor, wherein a source of the first transistor couples to the ramp signal generator, a gate of the first transistor couples to an input end of the most significant bit to receive the most significant bit, a drain of the first transistor couples to an output end of the ramp signal to output the ramp signal; and
using a second transistor, wherein a source of the second transistor couples to the reverse circuit, a gate of the second transistor couples to the input end of the most significant bit to receive the most significant bit, a drain of the second transistor couples to the output end of the ramp signal to output the ramp signal.

12. The driving method as claimed in claim 11, further comprising using a P-type transistor to be the first transistor and using an N-type transistor to be the second transistor.

13. The driving method as claimed in claim 11, further comprising using an N-type transistor to be the first transistor and using a P-type transistor to be the second transistor.

14. The driving method as claimed in claim 8, wherein during the longest clock counted time represented by the remaining (N-1) bits of the N-bits digital image data, the ramp signal increases from the lowest voltage to the highest voltage.

15. The driving method as claimed in claim 8, wherein during the longest clock counted time represented by the remaining (N-1) bits of the N-bit digital image data, the ramp signal decreases from the highest voltage to the lowest voltage.
